(19) United States
(12) Patent Application Publication
(10) Pub. No.: US 2025/0077835 A1
(43) Pub. Date: Mar. 6, 2025

(54) IMPLICIT DATA STORAGE AND RETRIEVAL USING CROSS-MODAL HOPFIELD ENCODING

(71) Applicant: International Business Machines Corporation, Armonk, NY (US)

(72) Inventors: Tanveer F. Syeda-Mahmood, San Jose, CA (US); Satyananda Kashyap, San Jose, CA (US)

(21) Appl. No.: 18/240,887

(22) Filed: Aug. 31, 2023

(51) Int. Cl. G06N 3/044

(52) U.S. Cl. CPC G06N 3/044

(57) ABSTRACT

The various embodiments disclosed herein provide methods, apparatus, and computer program products for implicit data storage and retrieval using cross-modal Hopfield encoding. One method includes a processor converting an original modality format of a unique associative data pattern to a different modality format of an original data content, concatenating the original data content and the converted unique associative data pattern to generate a concatenated data, and storing the concatenated data in a recurrent neural network (RNN) in which the original data content is associated to the unique associative data pattern at storage and the unique associative data pattern enables the original data content to be queried and retrieved from the RNN without using any of the content via the concatenation. Apparatus and computer program products that can perform the methods for implicit data storage and retrieval using cross-modal Hopfield encoding are also disclosed.

### FIELD

The subject matter disclosed herein relates to data storage and, more particularly, relates to implicit data storage and retrieval using cross-modal Hopfield encoding.

### BACKGROUND

With the growth of cloud data, the demand for data storage continues to grow and strategies that can store more data more compactly are needed. Traditionally, compression techniques have addressed this need. In addition, neural encoding techniques have also emerged that represent original data content through small-sized encodings. However, such approaches remain temporary because data storage continues to grow linearly with the number of files and will soon reach capacity limits.

Content addressable memories have been an alternative solution that store original data content implicitly using Hebbian recurrent learning by treating the various patterns as stable basins in an energy landscape and reconstructing the various patterns by giving a portion of the original data content again as a recall cue. That is, given a partial cue, content addressable memories can retrieve the stored pattern and are optimized through the use of Hebbian rule-based learning.

One limitation of implicit storage is the fact that the only way to recall original data content is by giving a piece of the original data content itself. This limitation is more evident in hybrid cloud situations because it is generally not possible for end-user to ask for original data content by giving a piece of the original data content itself. For example, if a end-user desires to retrieve a data file depicting an image, content addressable memory requires that a portion of the actual image be given as a query to trigger the memory to retrieve the image. This can be an issue because most human users query memories for original data content via a text format (e.g., ASCII characters).

### BRIEF SUMMARY

The various embodiments disclosed herein provide apparatus, methods, and computer program products for implicit data storage and retrieval using cross-modal Hopfield encoding. One apparatus includes a conversion module that converts an original modality format of a unique associative data pattern to a different modality format of an original data content, a concatenation module that concatenates the original data content and the converted unique associative data pattern to generate a concatenated data, and a storage module that stores the concatenated data in a recurrent neural network (RNN). Here, the original data content is associated to the unique associative data pattern at the time of store and the unique associative data pattern enables the original data content to be queried and retrieved from the RNN without using any of the original data content.

One method for implicit data storage and retrieval using cross-modal Hopfield encoding includes a processor converting an original modality format of a unique associative data pattern to a different modality format of an original data content, concatenating the original data content and the converted unique associative data pattern to generate a concatenated data, and storing the concatenated data in an RNN. Here, the original data content is associated to the unique associative data pattern at the time of store and the unique associative data pattern enables the original data content to be queried and retrieved from the RNN without using any of the content via the concatenation.

A computer program product for implicit data storage and retrieval using cross-modal Hopfield encoding includes a computer-readable storage medium including program instructions embodied therewith. The program instructions executable by a processor to cause the processor to convert an original modality format of a unique associative data pattern to a different modality format of an original data content, concatenate the original data content and the converted unique associative data pattern to generate a concatenated data, and store the concatenated data in an RNN. Here, the original data content is associated to the unique associative data pattern at the time of store and the unique associative data pattern enables the original data content to be queried and retrieved from the RNN without using any of the content via the concatenation.

An aspect of the various embodiments is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time.

### BRIEF DESCRIPTION OF THE DRAWINGS

So that at least some advantages of the technology may be readily understood, more particular descriptions of the embodiments briefly described above are rendered by reference to specific embodiments that are illustrated in the appended drawings. Understanding that the drawings included herein only depict some embodiments, the embodiments discussed herein are therefore not to be considered as limiting the scope of the technology. That is, the embodiments of the technology that are described and explained herein are done with specificity and detail utilizing the accompanying drawings, in which:

FIG. 1 is a block diagram of one embodiment of a system for implicit data storage and retrieval using cross-modal Hopfield encoding;

FIG. 2 is a block diagram of one embodiment of a storage system included in the system of FIG. 1;

FIG. 3 is a block diagram of one embodiment of a processor included in the storage system of FIG. 2;

FIG. 4 is a block diagram of one embodiment of an ingestion module included in the processor of FIG. 3;

FIG. 5 is a flow diagram illustrating example ingestion operations and/or functions in accordance with one embodiment of the processor of FIG. 2;

FIG. 6 is a block diagram of one embodiment of a retrieval module included in the processor of FIG. 3;

FIG. 7 is a flow diagram illustrating example retrieval operations and/or functions in accordance with one embodiment of the processor of FIG. 2;

FIG. 8 is a diagram illustrating one example of associating a unique data pattern with original data content and decoding encoded concatenated data to regenerate the original content data;

FIG. 9 is a diagram illustrating the results of training at least one embodiment of a Hopfield Encoded Network; and

FIGS. 10 through 15 are schematic flow chart diagrams illustrating various embodiments of a method for implicit data storage and retrieval using cross-modal Hopfield encoding.

### DETAILED DESCRIPTION

Disclosed herein are various embodiments providing apparatus, systems, computer program products, and methods for implicit data storage and retrieval using cross-modal Hopfield encoding. Notably, the language used in the present disclosure has been principally selected for readability and instructional purposes, and not to limit the scope of the subject matter disclosed herein in any manner.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “including,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more,” unless expressly specified otherwise.

In addition, as used herein, the term “set” can mean “one or more,” unless expressly specified otherwise. The term “sets” can mean multiples of or a plurality of “one or mores,” “ones or more,” and/or “ones or mores” consistent with set theory, unless expressly specified otherwise.

Further, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

The present technology may be a system, a method, and/or a computer program product. The computer program product may include a computer-readable storage medium (or media) including computer-readable program instructions thereon for causing a processor to carry out aspects of the present technology.

The computer-readable storage medium may be a tangible device that can retain and store instructions for use by an instruction execution device. The computer-readable storage medium may be, but is not limited to, for example, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove including instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present technology may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer-readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). To perform aspects of the present technology, in some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry.

Aspects of the present technology are described herein with reference to flowchart illustrations and/or block diagrams of methods, apparatus (systems), and computer program products according to embodiments of the technology. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium including instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present technology. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

To more particularly emphasize their implementation independence, many of the functional units described in this specification have been labeled as modules. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of program instructions may, for instance, comprise one or more physical or logical blocks of computer instructions which may, for instance, be organized as an object, procedure, or function. Nevertheless, the executables of an identified module need not be physically located together and may comprise disparate instructions stored in different locations which, when joined logically together, comprise the module and achieve the stated purpose for the module.

Furthermore, the described features, structures, or characteristics of the embodiments may be combined in any suitable manner. In the following description, numerous specific details are provided, such as examples of programming, software modules, end-user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

The schematic flowchart diagrams and/or schematic block diagrams in the Figures illustrate the architecture, functionality, and operation of possible implementations. It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Although various arrow types and line types may be employed in the flowchart and/or block diagrams, they are understood not to limit the scope of the corresponding embodiments. Indeed, some arrows or other connectors may be used to indicate only an exemplary logical flow of the depicted embodiment.

The description of elements in each figure below may refer to elements of proceeding figures. For instance, like numbers can refer to similar elements in all figures, including alternate embodiments of similar elements.

The various embodiments disclosed herein provide apparatus, methods, and computer program products for implicit data storage and retrieval using cross-modal Hopfield encoding. One apparatus for implicit data storage and retrieval using cross-modal Hopfield encoding includes a generation module that converts an original modality format of a unique associative data pattern to a different modality format of an original data content, a concatenation module that concatenates the original data content and the converted unique associative data pattern to generate a concatenated data, and a storage module that stores the concatenated data in a recurrent neural network (RNN) in which the original data content is associated to the unique associative data pattern at storage and the unique associative data pattern enables the original data content to be queried and retrieved from the RNN without using any of the original data content. The apparatus is more accurate and/or is able to fully reconstruct a query in an RNN and/or Hopfield Network in fewer iterations than traditional apparatus, RNNs, and/or Hopfield Networks. In this manner, the apparatus may be considered “faster” than traditional apparatus, RNNs, and/or Hopfield Networks because the apparatus disclosed herein uses less iterations to accurately fully reconstruct a query compared to traditional apparatus, RNNs, and/or Hopfield Networks. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL as examples) name of the content which is expected to be unique. The preceding subject matter of this paragraph characterizes example 1 of the present disclosure.

In some embodiments, the apparatus includes a selection module that selects a unique data pattern and associates the unique data pattern with the original data content to generate the unique associative data pattern. Associating the unique associative data pattern and the original data content allows/enables the apparatus to connect and/or link the original data content and the unique associative data pattern. The preceding subject matter of this paragraph characterizes example 2 of the present disclosure, in which example 2 also includes the subject matter according to example 1, above.

The apparatus, in certain embodiments, includes a conversion module that encodes the original data content and encodes the converted unique associative data pattern prior to concatenation of the original data content and the converted unique associative data pattern. Encoding the unique associative data pattern and the original data content allows/enables the apparatus to more efficiently identify and/or retrieve the original data content and the converted unique associative data pattern from the RNN. The preceding subject matter of this paragraph characterizes example 3 of the present disclosure, in which example 3 also includes the subject matter according to examples 1 and/or 2, above.

The apparatus further includes an end-user associative pattern selection module that receives a selection of a target unique associative data pattern including the original modality format and in which the generation module is further configured to convert the original modality format of the target unique associative data pattern to the different modality format. The end-user associative pattern selection module allows/enables the end-user to make the selection using a user-friendly input (e.g., typing, mouse, etc.). The preceding subject matter of this paragraph characterizes example 4 of the present disclosure, in which example 4 also includes the subject matter according to example 1, above.

In some embodiments, the generation module is further configured to retrieve the concatenated data using the target unique associative data pattern including the different modality format and the apparatus further includes a deconversion module that, in response to retrieval of the concatenated data, decodes the encoded unique associative data pattern and the encoded original data content of the concatenated data to generate the unique associative data pattern and the original data content. Decoding the concatenated data allows/enables the apparatus to return the unique associative data pattern and the original data content to their original format. The preceding subject matter of this paragraph characterizes example 5 of the present disclosure, in which example 4 also includes the subject matter according to examples 1, and/or 4, above.

In some embodiments, the deconversion module is further configured to verify whether the decoded and reconverted unique associative data pattern matches the unique associative data pattern including the original modality format. The deconversion module allows/enables the apparatus to verify that the retrieved data is the desired original data content of a query. The preceding subject matter of this paragraph characterizes example 6 of the present disclosure, in which example 6 also includes the subject matter according to examples 1, 4, and/or 5, above.

In various embodiments, the original modality format of the unique associative data pattern includes a text format, the different modality format of the original data content includes an image format, the unique associative data pattern includes an ASCII string of characters, and the RNN includes a Hopfield Network. Here, the apparatus is able to utilize a text query to a Hopfield Network to retrieve image data from the Hopfield Network without using any of the image data. The preceding subject matter of this paragraph characterizes example 7 of the present disclosure, in which example 7 also includes the subject matter according to example 1, above.

A method for implicit data storage and retrieval using cross-modal Hopfield encoding includes converting, by a processor, an original modality format of a unique associative data pattern to a different modality format of an original data content, concatenating, by the processor, the original data content and the converted unique associative data pattern to generate a concatenated data, and storing, by the processor, the concatenated data in a recurrent neural network (RNN) in which the original data content is associated to the unique associative data pattern at storage and the unique associative data pattern enables the original data content to be queried and retrieved from the RNN without using any of the content via the concatenation. The method and/or processor is more accurate and/or is able to fully reconstruct a query in an RNN and/or Hopfield Network in fewer iterations than traditional methods, processors, RNNs, and/or Hopfield Networks. In this manner, the method and/or processor may be considered “faster” than traditional methods, processors, RNNs, and/or Hopfield Networks because the method and/or processor disclosed herein use less iterations to accurately fully reconstruct a query compared to traditional methods, processors, RNNs, and/or Hopfield Networks. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL as examples) name of the content which is expected to be unique. The preceding subject matter of this paragraph characterizes example 8 of the present disclosure.

In some embodiments, the method includes selecting, by the processor, a unique data pattern and associating, by the processor, the unique data pattern and the original data content to generate the unique associative data pattern. Associating the unique associative data pattern and the original data content allows/enables the method and/or processor to connect and/or link the original data content and the unique associative data pattern. The preceding subject matter of this paragraph characterizes example 9 of the present disclosure, in which example 9 also includes the subject matter according to example 8, above.

The method, in certain embodiments, includes encoding, by the processor, the original data content and the converted unique associative data pattern prior to concatenation of the original data content and the converted unique associative data pattern. Encoding the unique associative data pattern and the original data content allows/enables the method and/or processor to more efficiently identify and/or retrieve the original data content and the converted unique associative data pattern from the RNN. The preceding subject matter of this paragraph characterizes example 10 of the present disclosure, in which example 10 also includes the subject matter according to examples 8 and/or 9, above.

In certain embodiments, the method includes receiving, by the processor, a selection of a target unique associative data pattern including the original modality format and converting, by the processor, the original modality format of the target unique associative data pattern to the different modality format. The method allows/enables an end-user to make a selection using a user-friendly input (e.g., typing, mouse, etc.). The preceding subject matter of this paragraph characterizes example 11 of the present disclosure, in which example 11 also includes the subject matter according to example 8, above.

In some embodiments, the method includes retrieving, by the processor, the concatenated data using the target unique associative data pattern including the different modality format and decoding, by the processor, the encoded unique associative data pattern and the encoded original data content of the concatenated data to generate the unique associative data pattern and the original data content in response to retrieval of the concatenated data. Decoding the concatenated data allows/enables the method and/or processor to return the unique associative data pattern and the original data content to their original format. The preceding subject matter of this paragraph characterizes example 11 of the present disclosure, in which example 12 also includes the subject matter according to examples 8 and/or 11, above.

In some embodiments, the method includes verifying, by the processor, whether the decoded and reconverted unique associative data pattern matches the unique associative data pattern including the original modality format. Verification allows/enables the method and/or processor to verify that the retrieved data is the desired original data content of a query. The preceding subject matter of this paragraph characterizes example 13 of the present disclosure, in which example 13 also includes the subject matter according to examples 8, 11, and/or 12, above.

In various embodiments, the original modality format of the unique associative data pattern includes a text format, the different modality format of the original data content includes an image format, the unique associative data pattern includes an ASCII string of characters, and the RNN includes a Hopfield Network. Here, the method and/or processor is/are able to utilize a text query to a Hopfield Network to retrieve image data from the Hopfield Network without using any of the image data. The preceding subject matter of this paragraph characterizes example 14 of the present disclosure, in which example 14 also includes the subject matter according to example 8, above.

A computer program product for implicit data storage and retrieval using cross-modal Hopfield encoding includes a computer-readable storage medium including program instructions embodied therewith in which the program instructions are executable by a processor to cause the processor to convert an original modality format of a unique associative data pattern to a different modality format of an original data content, concatenate the original data content and the converted unique associative data pattern to generate a concatenated data, and store the concatenated data in a recurrent neural network (RNN) in which the original data content is associated to the unique associative data pattern at storage and the unique associative data pattern enables the original data content to be queried and retrieved from the RNN without using any of the content via the concatenation. The computer program product and/or processor is more accurate and/or is able to fully reconstruct a query in an RNN and/or Hopfield Network in fewer iterations than traditional computer program products, program instructions, processors, RNNs, and/or Hopfield Networks. In this manner, the computer program product, program instructions, and/or processor may be considered “faster” than traditional computer program products, program instructions, processors, RNNs, and/or Hopfield Networks because the computer program product, program instructions, and/or processor disclosed herein use less iterations to accurately fully reconstruct a query compared to traditional computer program products, program instructions, processors, RNNs, and/or Hopfield Networks. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL as examples) name of the content which is expected to be unique. The preceding subject matter of this paragraph characterizes example 15 of the present disclosure.

The program instructions of the computer program product, in some embodiments, further cause the processor to select a unique data pattern and associate the unique data pattern and the original data content to generate the unique associative data pattern. Associating the unique associative data pattern and the original data content allows/enables the computer program product, program instructions, and/or processor to connect and/or link the original data content and the unique associative data pattern. The preceding subject matter of this paragraph characterizes example 16 of the present disclosure, in which example 16 also includes the subject matter according to example 15, above.

In some embodiments, the program instructions of the computer program product further cause the processor to encode the original data content and the converted unique associative data pattern prior to concatenation of the original data content and the converted unique associative data pattern. Encoding the unique associative data pattern and the original data content allows/enables the computer program product, program instructions, and/or processor to more efficiently identify and/or retrieve the original data content and the converted unique associative data pattern from the RNN. The preceding subject matter of this paragraph characterizes example 17 of the present disclosure, in which example 17 also includes the subject matter according to examples 15 and/or 16, above.

In certain embodiments, the program instructions of the computer program product further cause the processor to receive a selection of a target unique associative data pattern including the original modality format and convert the original modality format of the target unique associative data pattern to the different modality format. The computer program product, program instructions, and/or processor allows/enables an end-user to make a selection using a user-friendly input (e.g., typing, mouse, etc.). The preceding subject matter of this paragraph characterizes example 18 of the present disclosure, in which example 18 also includes the subject matter according to example 15, above.

The program instructions of the computer program product, in certain embodiments, further cause the processor to retrieve the concatenated data using the target unique associative data pattern including the different modality format and decode the encoded unique associative data pattern and the encoded original data content of the concatenated data to generate the unique associative data pattern and the original data content in response to retrieval of the concatenated data. Decoding the concatenated data allows/enables the computer program product, program instructions, and/or processor to return the unique associative data pattern and the original data content to their original format. The preceding subject matter of this paragraph characterizes example 19 of the present disclosure, in which example 19 also includes the subject matter according to examples 15 and/or 18, above.

The program instructions of the computer program product, in certain embodiments, further cause the processor to verify whether the decoded and reconverted unique associative data pattern matches the unique associative data pattern including the original modality format. Verification allows/enables the computer program product, program instructions, and/or processor to verify that the retrieved data is the desired original data content of a query. The preceding subject matter of this paragraph characterizes example 20 of the present disclosure, in which example 20 also includes the subject matter according to examples 15, 18, and/or 19, above.

In various embodiments, the original modality format of the unique associative data pattern includes a text format, the different modality format of the original data content includes an image format, the unique associative data pattern includes an ASCII string of characters, and the RNN includes a Hopfield Network. Here, the computer program product, program instructions, and/or processor is/are able to utilize a text query to a Hopfield Network to retrieve image data from the Hopfield Network without using any of the image data.

In various embodiments, an apparatus for implicit data storage and retrieval using cross-modal Hopfield encoding includes a generation module that converts an original modality format of a unique associative data pattern to a different modality format of an original data content, a concatenation module that concatenates the original data content and the converted unique associative data pattern to generate a concatenated data, and a storage module that stores the concatenated data in a recurrent neural network (RNN) in which the original data content is associated to the unique associative data pattern at storage, the unique associative data pattern enables the original data content to be queried and retrieved from the RNN without using any of the original data content, the original modality format of the unique associative data pattern includes a text format, the different modality format of the original data content includes an image format, the unique associative data pattern includes an ASCII string of characters, and the RNN includes a Hopfield Network. The apparatus disclosed herein is more accurate and/or is able to fully reconstruct a query in an RNN and/or Hopfield Network in fewer iterations than traditional RNNs and/or Hopfield Networks. In this manner, the apparatus may be considered “faster” than traditional RNNs and/or Hopfield Networks because the apparatus uses less iterations to accurately fully reconstruct a query compared to traditional RNNs and/or Hopfield Networks. In addition, the apparatus disclosed herein is able to utilize a text query to a Hopfield Network to retrieve image data from the Hopfield Network without using any of the image data. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL as examples) name of the content, which is expected to be unique.

A method for implicit data storage and retrieval using cross-modal Hopfield encoding, in various embodiments, includes a processor converting an original modality format of a unique associative data pattern to a different modality format of an original data content, concatenating the original data content and the converted unique associative data pattern to generate a concatenated data, and storing the concatenated data in a recurrent neural network (RNN) in which the original data content is associated to the unique associative data pattern at storage, the unique associative data pattern enables the original data content to be queried and retrieved from the RNN without using any of the original data content, the original modality format of the unique associative data pattern includes a text format, the different modality format of the original data content includes an image format, the unique associative data pattern includes an ASCII string of characters, and the RNN includes a Hopfield Network. The method and/or processor disclosed herein is/are more accurate and/or is able to fully reconstruct a query in an RNN and/or Hopfield Network in fewer iterations than traditional methods, processors, RNNs, and/or Hopfield Networks. In this manner, the method and/or processor may be considered “faster” than traditional methods, processors, RNNs, and/or Hopfield Networks because the method and/or processor disclosed herein use less iterations to accurately fully reconstruct a query compared to traditional methods, processors, RNNs and/or Hopfield Networks. In addition, the method and/or processor disclosed herein is/are able to utilize a text query to a Hopfield Network to retrieve image data from the Hopfield Network without using any of the image data. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL, as examples) name of the content, which is expected to be unique.

In various embodiments, a computer program product for implicit data storage and retrieval using cross-modal Hopfield encoding includes a computer-readable storage medium including program instructions embodied therewith in which the program instructions are executable by a processor to cause the processor to convert an original modality format of a unique associative data pattern to a different modality format of an original data content, concatenate the original data content and the converted unique associative data pattern to generate a concatenated data, and store the concatenated data in a recurrent neural network (RNN) in which the original data content is associated to the unique associative data pattern at storage, the unique associative data pattern enables the original data content to be queried and retrieved from the RNN without using any of the original data content, the original modality format of the unique associative data pattern includes a text format, the different modality format of the original data content includes an image format, the unique associative data pattern includes an ASCII string of characters, and the RNN includes a Hopfield Network. The computer program product, program instructions, and/or processor is/are more accurate and/or is able to fully reconstruct a query in an RNN and/or Hopfield Network in fewer iterations than traditional computer program products, program instructions, processors, RNNs, and/or Hopfield Networks. In this manner, the computer program product, program instructions, and/or processor disclosed herein may be considered “faster” than traditional computer program products, program instructions, processors, RNNs, and/or Hopfield Networks because the computer program product, program instructions, and/or processor disclosed herein use less iterations to accurately fully reconstruct a query compared to traditional computer program products, program instructions, processors, RNNs and/or Hopfield Networks. In addition, the computer program product, program instructions and/or processor disclosed herein is/are able to utilize a text query to a Hopfield Network to retrieve image data from the Hopfield Network without using any of the image data. An aspect of this embodiment is the ease of use in that the unique associative data pattern is generated rather than stored explicitly using an algorithm transparent to the end-user. In other words, the end-user does not need to remember or recall the associative data pattern in order to retrieve the original pattern. The generation process at retrieval time is identical to the one used at ingestion or storage time. The key to the generation is to ensure the unique association with the corresponding content being stored. That is, no two content patterns stored will share the same association pattern. An example of such unique association is achieved by the fully specified (actual name, path where it is stored or URL as examples) name of the content, which is expected to be unique.

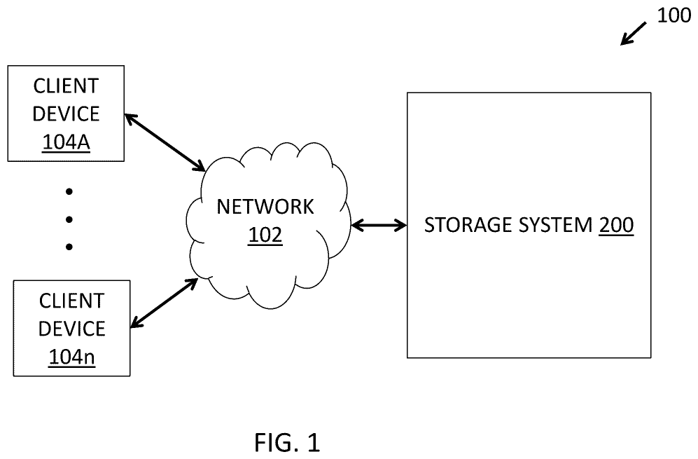

With reference now to the drawings, FIG. 1 is a block diagram of one embodiment of a computing network 100 (or system) for implicit data storage and retrieval using cross-modal Hopfield encoding. At least in the illustrated embodiment, the computing network 100 includes a network 102 connecting a set of one or more client devices 104A through 104n (also simply referred individually, in various groups, or collectively as client device(s) 104) and a storage system 200.

The network 102 may include any suitable wired and/or wireless network 102 (e.g., public and/or private computer networks in any number and/or configuration (e.g., the Internet, an intranet, a cloud network, etc.)) that is known or developed in the future that enables the set of client devices 104 and the storage system 200 to be coupled to and/or in communication with one another and/or to share resources. In various embodiments, the network 102 can include a cloud network (IAN), a SAN (e.g., a storage area network, a small area network, a server area network, and/or a system area network), a wide area network (WAN), a local area network (LAN), a wireless local area network (WLAN), a metropolitan area network (MAN), an enterprise private network (EPN), a virtual private network (VPN), and/or a personal area network (PAN), among other examples of computing networks and/or or sets of computing devices connected together for the purpose of sharing resources that are possible and contemplated herein.

A client device 104 can include any suitable computing hardware and/or software (e.g., a thick client, a thin client, or hybrid thereof) capable of accessing the storage system 200 via the network 102. Each client device 104, as part of its respective operation, relies on sending I/O requests to the storage system 200 to write data, read data, and/or modify data. Specifically, each client device 104 can transmit I/O requests to read, write, store, communicate, propagate, and/or transport instructions, data, computer programs, software, code, routines, etc., to the storage system 200 and may include at least a portion of a client-server model. In general, the storage system 200 can be accessed by the client device(s) 104 and/or communication with the storage system 200 can be initiated by the client device(s) 104 through a network socket (not shown) utilizing one or more inter-process networking techniques.

While the computing network 100 illustrated in FIG. 1 includes two (2) client devices 104 (e.g., client devices 104A and 104n), the various embodiments of the computing network 100 are not limited to two client devices 104. That is, a computing network 100 may include one (1) client device 104 or a quantity of client devices 104 that is greater than two client devices 104. In other words, various other embodiments of the computing network 100 may include any suitable of quantity of client devices 104.

A storage system 200 may include any suitable hardware and/or software capable of performing data storage processes, functions, and/or algorithms, as discussed elsewhere herein. In various embodiments, a storage system 200 may include any suitable computing storage system and/or computing storage device(s) that can store computer-readable data and/or computer-usable data. In some embodiments, the storage system 200 includes hardware and/or software configured to execute instructions in one or more modules and/or applications for implicit data storage and retrieval using cross-modal Hopfield encoding, as discussed elsewhere herein.

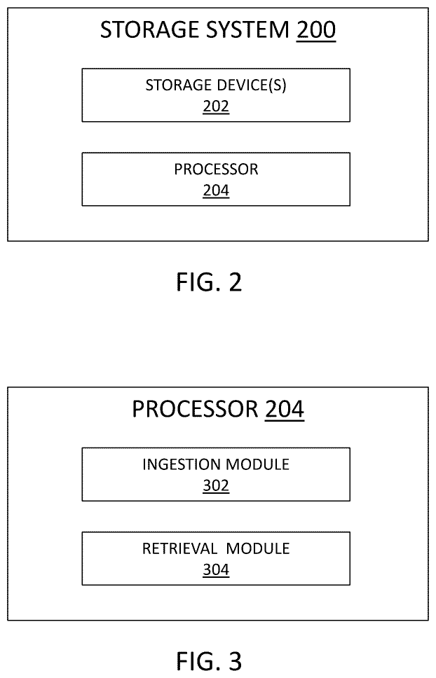

Referring to FIG. 2, FIG. 2 is a block diagram of one embodiment of a storage system 200 for implicit data storage and retrieval. In various embodiments, the storage system 200 includes a recurrent neural network (RNN). In certain embodiments, the RNN includes a RNN associative memory structure. In additional or alternative embodiments, the RNN includes a Hopfield Network.

The RNN and/or Hopfield Network includes an energy-based system that includes basins of attraction to store and complete patterns. Given a partial cue, the RNN and/or Hopfield Encoding Network can retrieve the stored pattern. In certain embodiments, the RNN and/or Hopfield Network is/are optimized using Hebbian rule-based learning or using a back propagation technique that can optimize a deep learning method.

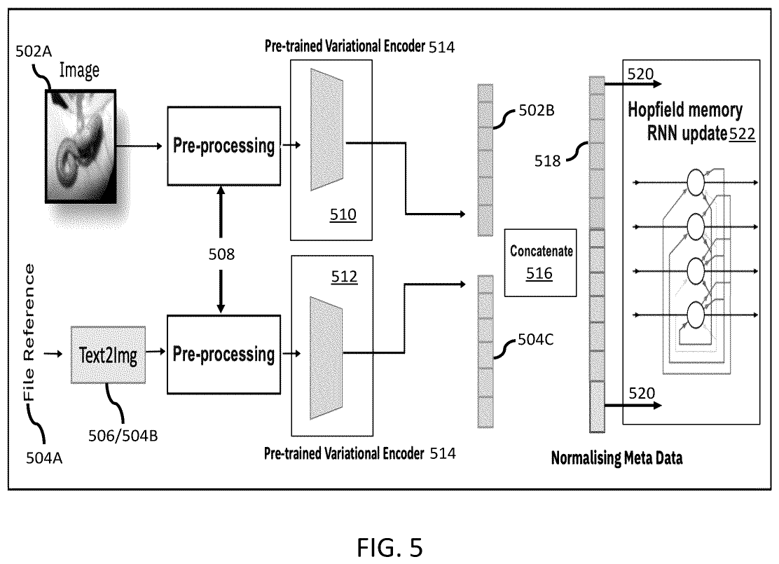

In certain embodiments, the RNN and/or Hopfield Network includes a result indicating an energy function providing a theoretical infinite storage capacity (see, e.g., Hopfield Encoded Network 522 in FIG. 5). Here, the RNN, Hopfield Network, and/or Hopfield Encoded Network 522 may include any of the device(s), structure(s), and/or function(s) as the Hopfield Network discussed in the article entitled, “Dense Associative Memory for Pattern Recognition,” authored by Dmitry Krotov and John J. Hopfield (2016) (https://arxiv.org/abs/1606.01164). Here, the energy function of the RNN, Hopfield Network, and/or Hopfield Encoded Network 522 is able to store a large number of data files and/or original data content.

In various embodiments, the RNN, Hopfield Network, and/or Hopfield Encoded Network 522 uses a unique associative data pattern with the stored data content (e.g., original data content) so that the unique associative data pattern can be used to query and recover the original data content instead of requiring a portion of the original data content needing to be given as the query. The unique associative data pattern, in various embodiments, includes one or more of the following characteristics:
(a) The unique associative data pattern is uniquely related to the original data content (e.g., there is a one-to-one mapping relating the original data content and the unique associative data pattern);
(b) The unique associative data pattern is digitally generated on-the-fly (or in real time) both during ingestion and recall so that the unique associative data pattern does not add to the storage requirement;
(c) The modality format and/or modality type of the unique associative data pattern for storage is compatible with the modality format and/or modality type of the original data content being stored (e.g., stored original image data content is associated with a unique associative image data pattern, stored original audio data content is associated with a unique associative audio data pattern, stored original video data content is associated with a unique associative video data pattern, stored original text data content is associated with a unique associative text data pattern, etc.);
(d) The modality format and/or modality type of the unique associative data pattern for search and recall is compatible with the modality format and/or modality type of the query (e.g., image searches index to unique associative image data patterns, audio searches index to unique associative audio data patterns, video searches index to unique associative video data patterns, text searches index to a unique associative text data patterns, etc.); and
(e) The transformation and/or conversion from the modality format of the unique associative data pattern for search and recall to the modality format for associative recall from a RNN and/or Hopfield Network may be a process (e.g., an exact process) resulting in a unique associative data pattern directly corresponding to the original data content stored in the RNN and/or Hopfield Network.

At least in the illustrated embodiment, the computing system 200 includes, among other components, a set of storage devices 202. A set of storage devices 202 may include any suitable quantity of storage devices 202 that can store data for a particular application, function, and/or use. Further, each storage device 202 may include any suitable size and/or storage capacity that is known or developed in the future.

In addition, a storage device 202 may include any type of memory device(s) that is/are known or developed in the future that is/are capable of storing data. The storage device(s) 202, in various embodiments, can include and/or store a set of one or more data files storing data therein. The data and/or data files stored in a storage device 202 may include which may include any suitable data and/or data type that is/are known or developed in the future.

In various embodiments, a storage device 202 may include one or more non-transitory computer-usable mediums (e.g., readable, writable, etc.), which can include any non-transitory and/or persistent apparatus or device that can contain, store, communicate, propagate, and/or transport instructions, data, computer programs, software, code, routines, etc., for processing by or in connection with a computer processing device (e.g., the processor 204). Further, a storage device 202 may include non-volatile/persistent hardware and/or software configured to perform long-term data storage operations, including, but not limited to, data archiving, data backup, data mirroring, and/or data replicating data, etc., among other long-term data storage operations that are possible and contemplated herein. For instance, a storage device 202 may include non-volatile and/or persistent hardware and/or software configured for performing long-term data storage operations, which may include write operations, read operations, and/or read-write operations, etc., among other storage operations that are possible and contemplated herein.

In various embodiments, the storage device(s) 202 can be implemented as flash memory (e.g., a solid-state device (SSD) or other non-volatile storage devices that store persistent data). Further, a storage device 202, in some embodiments, may include non-transitory memory such as, for example, a dynamic random-access memory (DRAM) device, a static random-access memory (SRAM) device, a hard disk drive (HDD), storage tape (e.g., magnetic and/or virtual), and/or other types (e.g., non-volatile and/or persistent) of memory devices, etc., among other types of non-transitory memory that are possible and contemplated herein.

The computing system 200, at least in the illustrated embodiment, further includes, among other components, a processor 204. A processor 204 may include any suitable non-volatile/persistent hardware and/or software configured to perform and/or facilitate performing various processing functions and/or operations. In various embodiments, the processor 204 includes hardware and/or software for executing instructions in one or more modules (and/or applications). The module(s) executed by the processor 204 can be stored on and executed from a storage device 202 and/or from the processor 204 for implicit data storage and retrieval using cross-modal Hopfield encoding.

Referring to FIG. 3, FIG. 3 is a schematic block diagram of one embodiment of a processor 204. At least in the illustrated embodiment, the processor 204 includes, among other components, features, and/or elements, an ingestion module 302 and a retrieval module 304 that are configured to operate/function together when executed by the processor 204 for implicit data storage and retrieval using cross-modal Hopfield encoding.

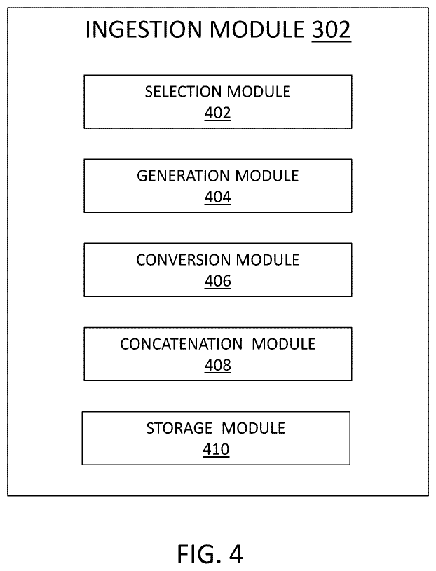

With reference to FIG. 4, FIG. 4 is a schematic block diagram of one embodiment of an ingestion module 302. At least in the illustrated embodiment, the ingestion module 302 includes, among other components, features, and/or elements, a selection module 402, a generation module 404, a conversion module 406, a concatenation module 408, and a storage module 410 that are configured to operate/function in conjunction with one another when executed by the processor 204 for implicit data storage using cross-modal Hopfield encoding.

A selection module 402 may include any suitable hardware and/or software that can select a unique associative data pattern for original data content. A selected unique associative data pattern may include any suitable type of data pattern that is known or developed in the future that can be associated with an original data content.

The unique associative data pattern may include any suitable data pattern that is, (a) unique (e.g., there is a single instance of this data pattern); (b) can be associated with a particular data content; and (c) includes an original modality format and/or modality format type that is capable of being converted to a different modality format and/or different modality format type. In various embodiments, the unique associative data pattern includes a text modality format, among other modality formats and/or modality format types that are possible, each of which is contemplated herein.

In at least some embodiments, the text modality format of the unique associative data pattern includes a string of ASCII characters, among other textual characters that are possible, each of which is contemplated herein. The string of ASCII characters forming the unique associative data pattern may include any suitable random and/or non-random unique string of ASCII characters that are capable of being associated with a particular data content and includes an original modality format and/or modality format type that is capable of being converted to a different modality format and/or different modality format type. Further, the string of ASCII characters forming the unique associative data pattern may include any suitable character length that enables the unique associative data pattern to be unique and associated with a particular data content. In addition, the string of ASCII characters forming the unique associative data pattern may include any suitable random and/or non-random character pattern that enables the unique associative data pattern to be unique and associated with a particular data content.

In various embodiments, the unique associative data pattern includes the file name (e.g., a unique file name) of the original data content with which the unique associative data pattern is associated. That is, the unique associative data pattern can include the fully specified path name of the original data content. For example, the unique file name can include a combination of ASCII letters, numbers, and/or symbols forming any suitable unique pattern that can be uniquely associated with the original data content.

In certain embodiments, if the fully specified path name of the original data content is too long and/or greater than a predetermined length, the selection module 402 is configured to shorten the fully specified path name. The selection module 402, in selecting the unique associative data pattern, may shorten the fully specified path name of the original data content to any suitable unique associative data pattern including any suitable length that does not violate the uniqueness of the fully specified path name and/or maintains the uniqueness of the fully specified path name for the original data content. To shorten the fully specified path name of the original data content, various embodiments of the selection module 402 is configured to apply a tiny Uniform Resource Locator (URL) conversion method to the fully specified path name of the original data content in selecting the unique associative data pattern.

In some embodiments, because the fully specified path name forming the unique associative data pattern is generated by the processor 204, the unique associative data pattern can be considered as being digitally generated. In additional or alternative embodiments, the file name forming the unique associative data pattern can be generated by a human (e.g., a user, an administrator, etc.).

The unique associative data pattern, in some embodiments, is digitally generated on-the-fly and/or in real time. In additional or alternative embodiments, the unique associative data pattern includes a small size or relatively small size such that the unique associative data pattern consumes a small amount or relatively small amount of storage real estate and/or makes up a small footprint on the storage system 200 and/or the storage device(s) 202. A generation module 404 may include any suitable hardware and/or software that can convert the modality format of data to another/different modality format. In various embodiments, the generation module 404 is configured to convert the modality format of a unique associative data pattern (see, e.g., unique associative text data pattern 504B in FIG. 5) to the modality format of original data content (see, e.g., original image data content 502A scheduled for storage on the storage device(s) 202). In other words, the generation module 404 is configured to convert the original modality format of the unique associative data pattern to the different modality format of the original data content so that the unique associative data pattern and the original data content include the same modality format.

The generation module 404, in various embodiments, is configured to identify an original modality format of the unique associative data pattern and a modality format (e.g., a different modality format) and/or a modality format type (e.g., a different modality format type) of the original data content. The generation module 404 is further configured to determine that the original modality format of the unique associative data pattern is to be converted to the different modality format and/or the different modality format type of the original data content in response to identifying the two different modality formats of the unique associative data pattern and the original data content.

In various embodiments, the generation module 404 is configured to convert a text modality format (e.g., an original modality format) of the unique associative data pattern to a different (or new) modality format and/or different (new) modality format type, which can include any suitable modality format and/or modality format type that is known or developed in the future that is different than the text modality format. In some embodiments (e.g., when the unique associative data pattern includes a text string or string of ASCII characters, etc.), the conversion module 404 is configured to convert the text modality format of the unique associative data pattern to an image modality format. That is, various embodiments of the generation module 404 are configured to convert an ASCII string of a tiny URL or fully specified pathname of the original data content (e.g., an image) to an image (e.g., an image modality). Here, the generated image includes the ASCII string of the tiny URL or fully specified pathname of the original data content “engraved” therein with a distinctive style and/or with a large enough font so that the ASCII pattern fits within the image and/or stands out against a background included in the image.

In other embodiments (e.g., when the unique associative data pattern includes a text string or string of ASCII characters, etc.), the generation module 404 is configured to convert the text modality format of the unique associative data pattern to an audio modality format, a video modality format, a text modality format, and/or the like modality formats and/or modality format types, among other modality formats and/or modality format types that are possible, each of which is contemplated herein. In some embodiments (e.g., the original data content includes an image modality format and the unique associative data pattern includes a text modality format), the generation module 404 is configured to utilize a digital text to image generation tool and/or technique to convert and/or transform the text modality format of the unique associative data pattern to a visual pattern and/or image pattern so that the unique associative data pattern and the original data content include the same (and/or compatible) modality format and/or modality format type (e.g., an image modality format). In other embodiments (e.g., the original data content includes a video modality format and the unique associative data pattern includes a text modality format), the generation module 404 is configured to utilize a digital text to video generation tool and/or technique to convert and/or transform the text modality format of the unique associative data pattern to a visual pattern and/or video pattern so that the unique associative data pattern and the original data content include the same (and/or compatible) modality format and/or modality format type (e.g., a video modality format). In certain embodiments (e.g., the original data content includes an audio modality format and the unique associative data pattern includes a text modality format), the conversion module 404 is configured to utilize a digital audio to image generation tool and/or technique to convert and/or transform the text modality format of the unique associative data pattern to an audio pattern so that the unique associative data pattern and the original data content include the same (and/or compatible) modality format and/or modality format type (e.g., an audio modality format). In still other embodiments (e.g., the original data content includes a text modality format and the unique associative data pattern includes a different text modality format), the generation module 404 is configured to utilize a digital text to (different) text generation tool and/or technique to convert and/or transform the text modality format of the unique associative data pattern to a different text pattern and/or visual pattern so that the unique associative data pattern and the original data content include the same (and/or compatible) modality format and/or modality format type (e.g., an image modality format and/or text modality format).

By converting the text modality format of the unique associative data pattern to a different (or new) modality format and/or different (new) modality format type, the generation module 404 enables/allows a end-user (human) to query the storage system 200 for data content including various modality formats and/or modality format types using end-user inputs (e.g., keyboard inputs, mouse inputs, and/or audio/voice inputs, etc.) when such end-user inputs includes an original modality format and/or original modality format type than the different modality format and/or different modality format type of the original data content stored on the storage system 200 and/or storage device(s) 202. In other words, by converting the text modality format of the unique associative data pattern to a different (or new) modality format and/or different (new) modality format type, the generation module 404 enables/allows a hybrid storage system (e.g., storage system 200) to be queried by a human/user in a conventional manner when such a query has been traditionally unavailable in RNN and/or Hopfield Networks, as discussed in greater detail elsewhere herein.

A conversion module 406 may include any suitable hardware and/or software that can encode or embed data. In certain embodiments, the conversion module 406 is configured to encode or embed the unique associative data pattern and the original data content.

The conversion module 406 may encode or embed the unique associative data pattern and the original data content using any suitable encoding and/or embedding algorithm, technique, and/or method that is known or developed in the future. In certain embodiments, the conversion module 406 is configured to apply an encoding method to the unique associative data pattern to produce an embedding or encoding with a vector length. Similarly, the conversion module 406 is configured to apply the encoding method to the original data content to produce another vector of the same length. For example, the conversion module 406 can encode an image an ASCII pattern (e.g., a unique associative data pattern for a target image) to produce an embedding or encoding of a vector length K and apply the same encoding method to the target image (e.g., an original data content) to produce another vector with the length K.

A concatenation module 408 may include any suitable hardware and/or software that can link and/or combine data. In various embodiments, the concatenation module 408 is configured to link and/or combine the encoded unique associative data pattern and the encoded original data content.

The encoded unique associative data pattern and the encoded original data content can be concatenated by the concatenation module 408 using any suitable concatenation technique and/or method that is known or developed in the future that can link and/or combine the encoded unique associative data pattern and the encoded original data content to generate concatenated data (see, e.g., concatenated data 518 in FIG. 5). That is, concatenated unique associative data pattern and original data content include the same modality format such that the concatenated data and/or concatenated data file includes a single modality format. In various embodiments, the concatenated data can be a data file that includes the unique associative data pattern and the original data content linked and/or combined together as storable, searchable, and retrievable concatenated data and/or as a single storable, searchable, and retrievable concatenated data file in a RNN and/or Hopfield Network.

In various embodiments of image, video, and/or text conversion performed by the generation module 404 as discussed above, the concatenation module 408 is configured to render the unique associative data pattern with the converted, changed, and/or different modality format and/or modality format type of the original data content so that the font of the text and/or text string of the unique associative data pattern is large and/or relatively large and legible (e.g., digitally legible) in the concatenated data (e.g., concatenated image data, concatenated video data, concatenated text data, etc.). In additional or alternative embodiments, the large/relatively large and legible text and/or text string resulting from the concatenation of the unique associative data pattern and the original data content occupies a large and/or relatively large portion of the concatenated data (e.g., concatenated image data, concatenated video data, concatenated text data, etc.).

A storage module 410 may include any suitable hardware and/or software that can store and/or facilitate storage of data and/or data files. In various embodiments, the storage module 410 is configured to store and/or facilitate storage of concatenated data and/or concatenated data files.

Concatenated data and/or concatenated data files can be stored by the storage module 410 using any suitable storage technique and/or method that is known or developed in the future that is capable of storing concatenated data and/or concatenated data files. In addition, concatenated data and/or concatenated data files can be stored by the storage module 410 using any suitable storage technique and/or method that is known or developed in the future that is capable of storing concatenated data and/or concatenated data files such that the concatenated data and/or concatenated data files are capable of being searched/queried and retrieved/recalled by a human/user, as discussed in greater detail elsewhere herein.

In various embodiments, the storage module 410 includes an RNN and/or Hopfield Network. Further, the RNN and/or Hopfield Network formed by the storage module 410 implicitly stores concatenated data and/or concatenated data files (e.g., the combined encoded unique associative data pattern and encoded original data content) through iterative optimization.

In various embodiments, the storage module 410 is configured to store the original data content (e.g., in the form of encoded concatenated data) to an RNN, Hopfield Network, and/or Hopfield Encoded Network 522 utilizing an energy minimization optimization operation. In certain embodiments, the energy minimization optimization operation can be represented by the following equation:

$${v}_{i}^{( t + 1 )} = {v}_{i}^{( t )} + \frac{d t}{{τ}_{f}} [ {\sum }_{μ = 1}^{{N}_{h}} {ε}_{i μ} softmax ( {\sum }_{j = 1}^{{N}_{f}} {ε}_{μ j} {v}_{j}^{( t )} ) - {v}_{i}^{( t )} ]$$

For example, during ingestion of the original data content and the unique associative data pattern, in various embodiments, both the original data content and the unique associative data pattern are neural encoded by an encode component of a pre-trained auto-encoder and/or a pre-trained variational encoder (see, e.g., pre-trained variational encoder 514 in FIG. 5). Here, the encodings of the original data content and the unique associative data pattern are subsequently concatenated by the concatenation module 408 to generate and/or form a joint encoding that is stored in a Hopfield Network, which can now be considered a Hopfield Encoded Network (see, e.g., Hopfield Encoded Network 522 in FIG. 5).

In various embodiments, the position of the split between the encoded original data content (see, e.g., encoded original image data content 502B) and the encoded unique associative data pattern (see, e.g., encoded unique associative text data pattern 504C) in the concatenated data (see, e.g., concatenated data 518) is a fixed parameter. In certain embodiments, the position of the split between the encoded original data content and unique associative data pattern in the concatenated data is a 50-50 split, among other splits that are possible, each of which is contemplated herein.

Referring to FIG. 5, FIG. 5 is a flow diagram illustrating example ingestion operations and/or functions in accordance with one embodiment of the processor 204 (and the ingestion module 302). In the illustrated example, the original data content includes original image data content 502A (including an image modality format) and a unique text data pattern 504A (including a text modality format).

After determining the image modality format of the original image data content 502A and text modality format of the unique text data pattern 504A, the processor converts 506 the text modality format of the unique text data pattern 504A to the image modality format of the original image data content 502A. Accordingly, the unique associative data pattern (or unique associative text data pattern) and the original image data content 502A now include the same modality format (or at least compatible modality formats). That is, the unique associative data pattern (or unique associative text data pattern) now includes an image modality format.

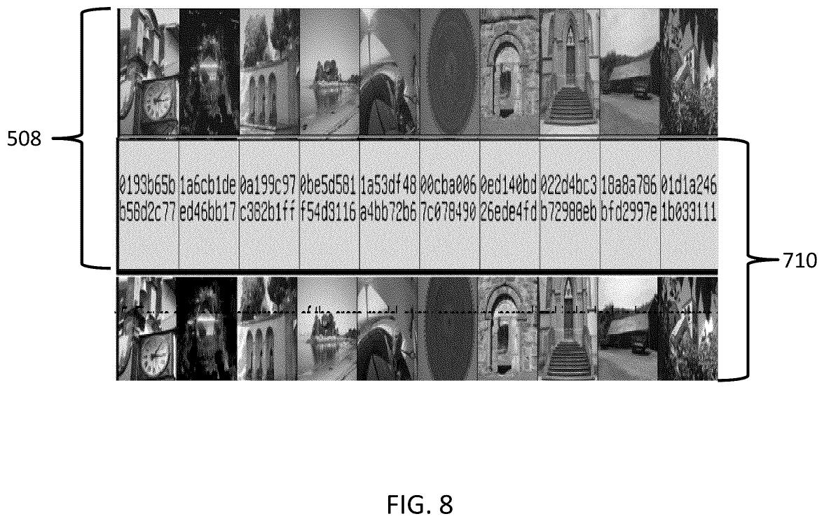

With the same image modality format, the processor 204 can pre-process the original image data content 502A and the unique text data pattern 504A to associate 508 (see, also, FIG. 8) the unique text data pattern 504A with the original image data content 502A. The association of the original image data content 502A with the unique text data pattern 504A allows the unique text data pattern 504A to become a unique associative text data pattern 504B (or unique associative data pattern) for the original image data content 502A.

The processor 204 encodes 510 the original image data content 502A to generate encoded original image data content 502B and encodes 512 the unique associative text data pattern 504B to generate an encoded unique associative text data pattern 504C. In certain embodiments, the original image data content 502A and the unique associative text data pattern 504B are neural encoded by an encode component of a pre-trained auto-encoder and/or a pre-trained variational encoder 514 to generate the encoded original image data content 502B and the encoded unique associative text data pattern 504C.

The encoded original image data content 502B and the encoded unique associative text data pattern 504C are concatenated 516 by the processor 204 to generate concatenated data 518. The processor stores 520 in a Hopfield Encoded Network 522 (or HEN 522).

In traditional Hopfield Networks, the unique text data pattern 504A could not be used to query and retrieve the original image data content 502A when stored in a Hopfield Network. The various embodiments disclosed herein allow and/or enable use of the unique text data pattern 504A to query and retrieve the original image data content 502A from the Hopfield Encoded Network 522.

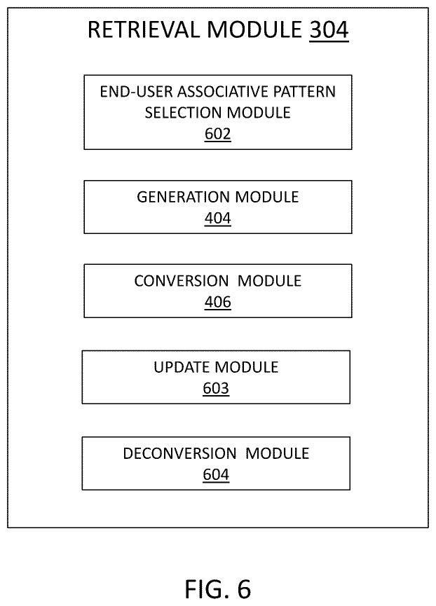

With reference to FIG. 6, FIG. 6 is a schematic block diagram of one embodiment of a retrieval module 304. At least in the illustrated embodiment, retrieval module 304 includes, among other components, features, and/or elements, an end-user associative data pattern selection module 602, the generation module 404, the conversion module 406, an update module 603, and a deconversion module 604 that are configured to operate/function together when executed by the processor 204 for implicit data retrieval using cross-modal Hopfield encoding.

An end-user associative data pattern selection module 602 may include any suitable hardware and/or software that can facilitate retrieval of an original data content using a unique associative data pattern. In various embodiments, the end-user associative data pattern selection module 602 may be considered an ease-of-use module to retrieve a unique associative data pattern to finally synthesize an original data pattern.

In some embodiments, the end-user associative data pattern selection module 602 is configured to generate and store a list of patterns (e.g., unique associative data patterns) associated with various data (e.g., various original data content) stored in storage system 200 and/or storage device(s) 202. The end-user associative data pattern selection module 602 can make the list directly available to a end-user and/or provide the list to a end-user utilizing any suitable viewing medium.

In certain embodiments, the list of patterns is made directly available and/or provided to an end-user on a browser table including a mechanism for the end-user to make a selection from the list indicating the user's intention to select a relevant and/or target unique associative data pattern. In one embodiment, the end-user is able to make a selection by “clicking on” a particular unique associative data pattern on the list of unique associative data patterns, among other techniques that are possible, each of which is contemplated herein.

In additional or alternative embodiments, the end-user associative data pattern selection module 602 is configured to associate and store each unique associative data pattern is a set of one or more keywords and/or search terms. The set of one or more keywords and/or search terms for each unique associative data pattern can be stored in a lexical text index, which can include any suitable lexical text index and/or type of lexical text index that is known or developed in the future. Further, the lexical text index can be queried by a search application, which can include any suitable search application and/or type of search application that is known or developed in the future.

For example, an end-user can input (e.g., type, etc.) a keyword and/or search term into a browser interface to retrieve a list of possible and/or candidate unique associative data patterns from the lexical text index through the search application. After the list of possible and/or candidate unique associative data patterns are made directly available and/or provided to the end-user on a browser table of results, the end-user can select a relevant and/or target unique associative data pattern.

The generation module 404 is further configured to receive a unique associative data pattern associated with and/or corresponding to a particular original data content desired/selected by a end-user (e.g., the relevant and/or target unique associative data pattern). The received unique associative data pattern for retrieving the particular original data content desired/selected by the end-user may include any of the embodiments of the unique associative data pattern discussed elsewhere herein and, particularly, with reference to the selection module 402.

In some embodiments, the received unique associative data pattern is received directly from a selection performed by a end-user (e.g., the end-user knows the name of the particular original data content to be retrieved or the encoded string form of the particular original data content), as discussed above. In alternative embodiments, the received unique associative data pattern is selected from the results produced by a search application, as discussed above.

The generation module 404, in various embodiments, is configured to identify an original modality format of the received unique associative data pattern and a modality format (e.g., a different modality format) and/or a modality format type (e.g., a different modality format type) of the particular original data content desired/selected by the user. The generation module 404 is further configured to determine that the original modality format of the received unique associative data pattern is to be converted to the different modality format and/or the different modality format type of the particular original data content desired/selected by a end-user in response to identifying the two different modality formats of the received unique associative data pattern and the particular original data content desired/selected by the user.

In various embodiments, the generation module 404 is configured to convert the modality format of the received unique associative data pattern to the modality format of the particular original data content desired/selected by the user. That is, the generation module 404 is configured to convert the original modality format of the received unique associative data pattern to the different modality format of the particular original data content desired by the user. In other words, the different modality format of the unique associative data pattern is reconverted to the original modality format of the unique associative data pattern.

The generation module 404, in some embodiments, renders the received unique associative data pattern as a unique associative image data pattern in response to the particular original data content desired by the end-user being image data content. In other embodiments, the generation module 404 renders the received unique associative data pattern as a unique associative video data pattern, a unique associative audio data pattern, and a unique associative text data pattern, etc. in response to the particular original data content desired by the end-user being video data content, audio data content, and text data content, etc., respectively. In various embodiments, the received unique associative data pattern is rendered as the unique associative image data pattern, unique associative video data pattern, unique associative audio data pattern, and unique associative text data pattern, etc. using a digital text to image generation tool and/or technique similar to the various embodiments discussed elsewhere herein.

The conversion module 406, in various embodiments, neural encodes the received unique associative data pattern using the encode component of a pre-trained auto-encoder and/or a pre-trained variational encoder that was used to neural encode the particular original data content desired by the end-user. In various embodiments, the resulting encoding (e.g., neural encoding) of the received unique associative data pattern serves as a partial content address for the particular original data content desired by the user. Further, the partial content address for the particular original data content desired by the end-user enables and/or allows the Hopfield Encoding Network 522 to retrieve the joint encoding of the original data content and the paired/associated unique associative data pattern forming the concatenated data stored in the Hopfield Encoding Network 522 because at least a portion of content address for any original data content is needed to locate and retrieve original data content from a RNN and/or Hopfield Network.

An update module 603 may include any suitable hardware and/or software that is capable of retrieving data from an RNN, Hopfield Network, and/or Hopfield Encoded Network 522. The update module 603, in various embodiments, is configured to utilize the partial content address for encoded concatenated data (e.g., the particular original data content desired by the end-user and its encoded unique associative data pattern) to retrieve original data content from an RNN, Hopfield Network, and/or Hopfield Encoded Network 522.

The update module 603 can utilize the partial content address to retrieve the encoded concatenated data from the RNN, Hopfield Network, and/or Hopfield Encoded Network 522 using any suitable data locating and/or data retrieval technique and/or method for an RNN and/or Hopfield Network that is/are known or developed in the future. In various embodiments, to retrieve the encoded concatenated data (e.g., the particular original data content desired by the end-user and its encoded unique associative data pattern), the update module 603 is configured to perform a Hopfield update technique and/or method utilizing the partial content address. In this manner the update module 603 can retrieve the original data content (e.g., in the form of the encoded concatenated data) from an RNN, Hopfield Network, and/or Hopfield Encoded Network 522 without using any of the actual data of the original data content desired by the end-user.

In various embodiments, the update module 603 is configured to retrieve the original data content (e.g., in the form of the encoded concatenated data) from an RNN, Hopfield Network, and/or Hopfield Encoded Network 522 utilizing an energy minimization optimization operation. In certain embodiments, the energy minimization optimization operation can be represented by the following equation:

$${v}_{i}^{( t + 1 )} = {v}_{i}^{( t )} + \frac{d t}{{τ}_{f}} [ {\sum }_{μ = 1}^{{N}_{h}} {ε}_{i μ} softmax ( {\sum }_{j = 1}^{{N}_{f}} {ε}_{μ j} {v}_{j}^{( t )} ) - {v}_{i}^{( t )} ]$$

Here, the energy minimization optimization operation used by the update module 603 to retrieve the original data content (e.g., in the form of the encoded concatenated data) from an RNN, Hopfield Network, and/or Hopfield Encoded Network 522 is the same energy minimization optimization operation used by the storage module 410 to store the original data content to the RNN, Hopfield Network, and/or Hopfield Encoded Network 522. Accordingly, various embodiments can use the same operation to store original data in and retrieve original data from an RNN, Hopfield Network, and/or Hopfield Encoded Network 522.

A deconversion module 604 may include any suitable hardware and/or software that can decode data content and/or data content files. In various embodiments, the deconversion module 604 is configured to decode the encoded concatenated data. That is, the deconversion module 604 can effectively decode the encoded original data content desired by the end-user and the encoded unique associative data pattern forming the encoded concatenated data stored in the RNN, Hopfield Network, and/or Hopfield Encoded Network 522 (storage system 200 and/or stage device(s) 202). The deconversion module 604 can decode the encoded original data content and encoded unique associative data pattern forming the encoded concatenated data using any suitable decoding tool (e.g., a decoder) and/or decoding technique that is/are known or developed in the future.

In various embodiments, the deconversion module 604 is configured to separate out and/or split off (e.g., de-concatenate) the original data content desired by the end-user and the unique associative data pattern connected/corresponding to the original data content desired by the end-user when decoding the encoded concatenated data. That is, decoding the encoded concatenated data returns the original data content desired by the end-user and its corresponding unique associative data pattern as separate data content and/or data content files. The original data content desired by the end-user can then be transmitted to the user.

The quality of the synthesized original pattern (e.g., original data content) is a function of the decoder used. As such, various embodiments use a decoder for image patterns to ensure accurate reconstruction of encoded image patterns.

The deconversion module 604 may further (e.g., optionally) include any suitable hardware and/or software that is capable of verifying data. In various embodiments, the deconversion module 604 is configured to verify that the correct original data content desired by the end-user was retrieved.

The deconversion module 604 can verify that the correct original data content desired by the end-user was retrieved using any suitable technique and/or method that is known or developed in the future. In various embodiments, the deconversion module 604 is configured to utilize the unique associative data pattern connected/corresponding to the original data content separate out and/or split off (e.g., de-concatenate) of the retrieved encoded concatenated data matches the received unique associative data pattern.

Determining that the unique associative data pattern connected/corresponding to the original data content separate out and/or split off (e.g., de-concatenate) of the retrieved encoded concatenated data matches the received unique associative data pattern can be performed using any suitable technique and/or method that is known or developed in the future. In some embodiments, a match is determined by comparing the unique associative data pattern connected/corresponding to the original data content separate out and/or split off (e.g., de-concatenate) of the retrieved encoded concatenated data and the received unique associative data pattern to determine whether they include the same unique data pattern.

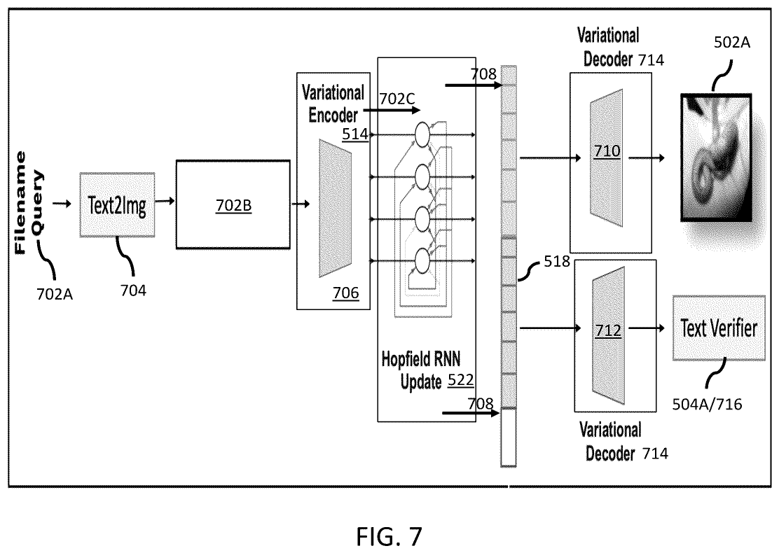

Referring to FIG. 7, FIG. 7 is a flow diagram illustrating example retrieval operations and/or functions in accordance with one embodiment of the processor 204 (and the retrieval module 304). In the illustrated example, the particular original data content desired by a end-user includes original image data content 502A (including an image modality format) and a received filename query includes a unique text data pattern 702A (including a text modality format).

After determining the image modality format of the particular original image data content 502A and text modality format of the filename query, the processor converts 704 the text modality format of the filename query 702A to the image modality format of the particular original image data content 502A. Accordingly, the unique text data pattern 702B (or unique data pattern) and the particular original image data content 502A now include the same modality format (or at least compatible modality formats). That is, the unique text data pattern 702B (or unique text data pattern) now includes an image modality format.

The processor 204 encodes 706 the unique text data pattern 702B to generate an encoded unique text data pattern 702C. In certain embodiments, the unique text data pattern 702B is neural encoded by the encode component of the pre-trained auto-encoder and/or pre-trained variational encoder 514 to generate the encoded unique text data pattern 702C.

The encoded unique text data pattern 702C forms a partial content address for encoded concatenated data 518 (e.g., the particular original data content desired by the end-user and its encoded unique associative data pattern). The partial content address for encoded concatenated data 518 is utilized to retrieve 708 the encoded concatenated data 518.

The encoded concatenated data 518 is split (e.g., de-concatenated) into the encoded particular original data content desired by the end-user and its encoded unique associative data pattern. The encoded particular original data content desired by the end-user is decoded 710 to generate the original data content 502A (see, also, FIG. 8) and its encoded unique associative data pattern is decoded 712 to generate its unique associative data pattern 504A, each of which can be decoded by a variational decoder 714.

Whether the retrieved original data content 502A is the correct original data content 502A can be verified 716. The correct original data content 502A can be verified 716 using the unique associative data pattern 504A, as discussed elsewhere herein.

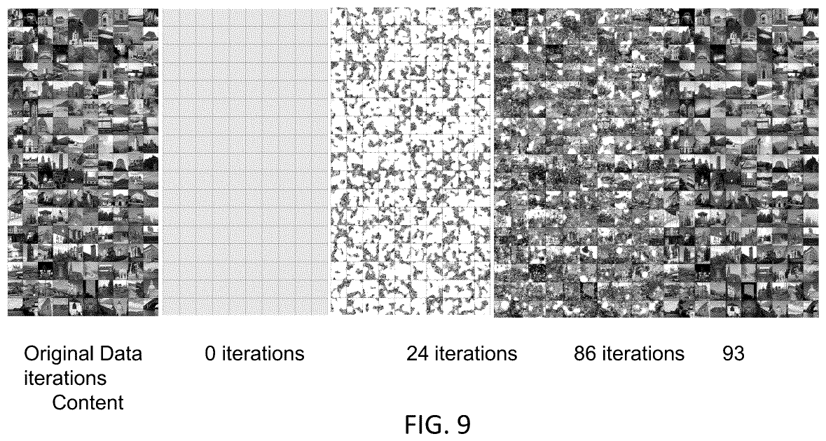

With reference to FIG. 9, FIG. 9 is a diagram illustrating the results of training the Hopfield Encoded Network 522 in accordance with various embodiments discussed herein. Specifically, FIG. 9 illustrates the training of the Hopfield Encoded Network 522 via the reconstruction of the original data content at zero (0) iterations, 24 iterations, 86 iteration, and 93 iterations.

As illustrated in FIG. 9, training the Hopfield Encoded Network 522 fully reconstructs in the original data content in 93 iterations. With the ability to fully reconstruct a query at 93 iterations in this example use case, the various embodiments discussed herein allow for larger number of images (indicating an increased capacity) of the Hopfield Encoded Network to reconstruct accurately without the introduction of meta stable states than traditional RNNs and/or Hopfield Networks. In this manner, the various embodiments discussed herein may be considered to include a reduced number of meta stable states for the same memory capacity and the further include the ability to fully reconstruct the image without any image inputs because of the cross modal linking than traditional RNNs and/or Hopfield Networks.

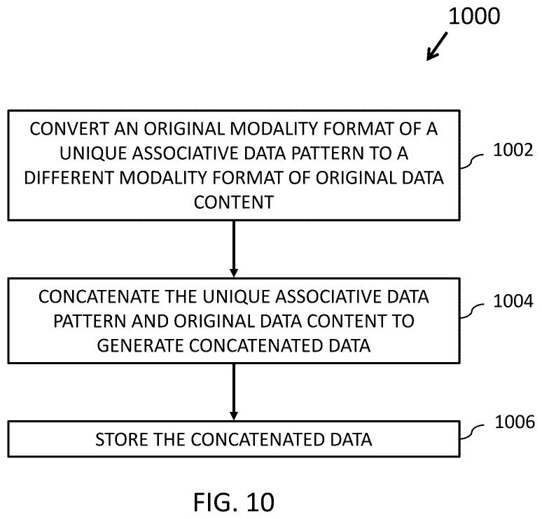

FIG. 10 is a schematic flow chart diagram illustrating one embodiment of a method 1000 for implicit data storage and retrieval using cross-modal Hopfield encoding. At least in the illustrated embodiment, the method 1000 begins by a processor 204 converting an original modality format of a unique associative data pattern to a different modality format of an original data content (block 1002).

The method 1000 further includes the processor 204 concatenating the original data content and the converted unique associative data pattern to generate a concatenated data (block 1004). The processor 204 stores the concatenated data in a recurrent neural network (block 1006).

In various embodiments, the original data content is associated to the unique associative data pattern. In addition, the unique associative data pattern enables the original data content to be queried and retrieved from the RNN without using any of the content via the concatenation.

In certain embodiments, the original modality format of the unique associative data pattern includes a text format and the different modality format of the original data content includes an image format. Further, the unique associative data pattern can include an ASCII string of characters and the RNN can include a Hopfield Network.

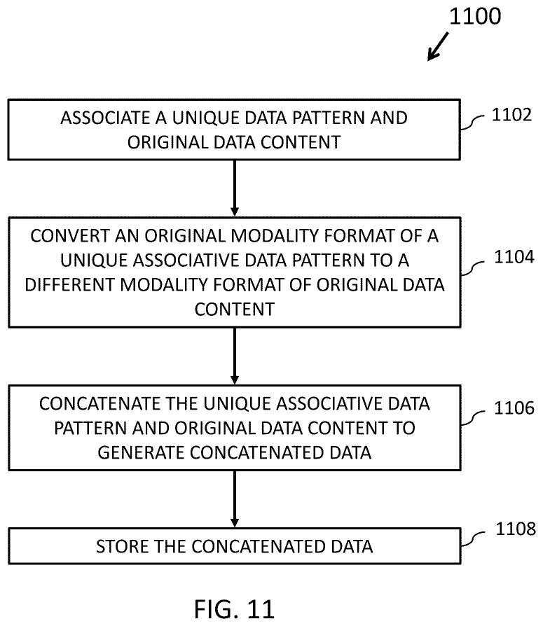

FIG. 11 is a schematic flow chart diagram illustrating another embodiment of a method 1100 for implicit data storage and retrieval using cross-modal Hopfield encoding. At least in the illustrated embodiment, the method 1100 begins by a processor 204 associating a unique data pattern and original data content (block 1102).

The method 1100 further includes the processor 204 converting an original modality format of the unique associative data pattern to a different modality format of the original data content (block 1104) and the processor 204 concatenating the original data content and the converted unique associative data pattern to generate a concatenated data (block 1106). The processor 204 stores the concatenated data in a recurrent neural network (block 1108).

In various embodiments, the original data content is associated to the unique associative data pattern. In addition, the unique associative data pattern enables the original data content to be queried and retrieved from the RNN without using any of the content via the concatenation.

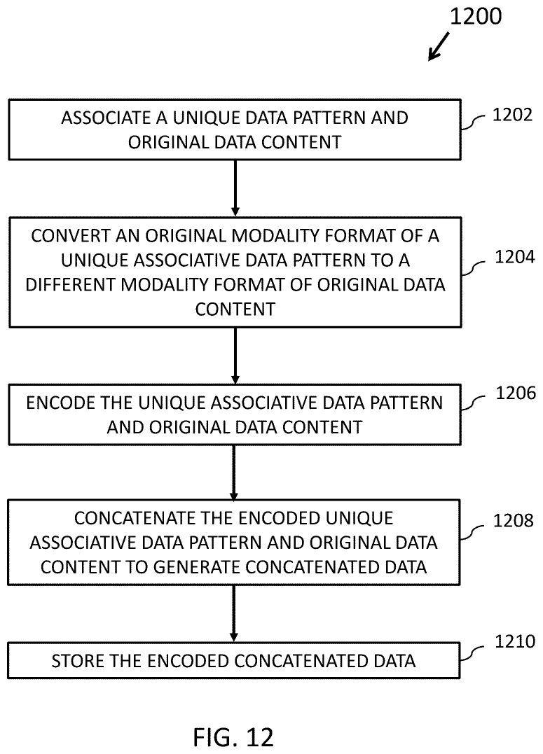

FIG. 12 is a schematic flow chart diagram illustrating another embodiment of a method 1200 for implicit data storage and retrieval using cross-modal Hopfield encoding. At least in the illustrated embodiment, the method 1200 begins by a processor 204 associating a unique associative data pattern and original data content (block 1202).

The method 1200 further includes the processor 204 converting an original modality format of the unique associative data pattern to a different modality format of the original data content (block 1204). The processor 204 also encodes the original data content and the converted unique associative data pattern (block 1206).

The processor 204 concatenates the encoded original data content and the encoded unique associative data pattern to generate encoded concatenated data (block 1208). That is, original data content and the unique associative data pattern are encoded prior to concatenation. The processor 204 stores the encoded concatenated data in a recurrent neural network (block 1210).

In various embodiments, the original data content is associated to the unique associative data pattern. In addition, the unique associative data pattern enables the original data content to be queried and retrieved from the RNN without using any of the content via the concatenation.

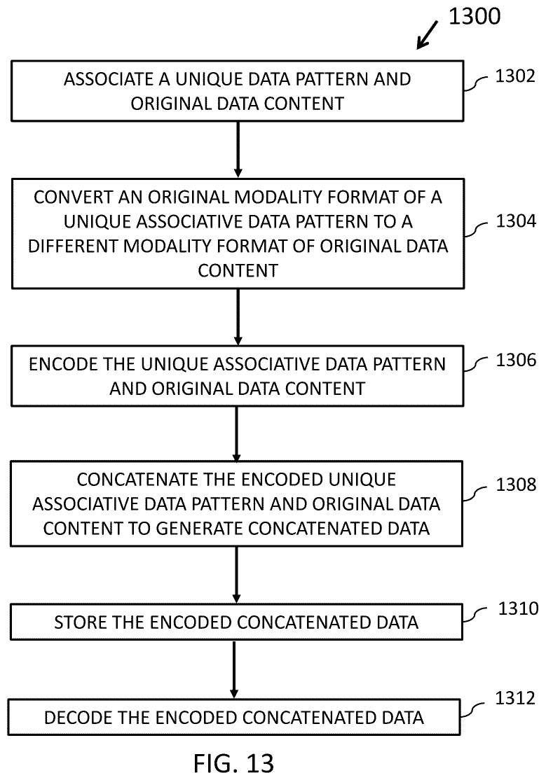

FIG. 13 is a schematic flow chart diagram illustrating another embodiment of a method 1300 for implicit data storage and retrieval using cross-modal Hopfield encoding. At least in the illustrated embodiment, the method 1300 begins by a processor 204 associating a unique associative data pattern and original data content (block 1302).

The method 1300 further includes the processor 204 converting an original modality format of the unique associative data pattern to a different modality format of the original data content (block 1304). The processor 204 also encodes the original data content and the converted unique associative data pattern (block 1306).

The processor 204 concatenates the encoded original data content and the encoded unique associative data pattern to generate encoded concatenated data (block 1308). That is, original data content and the unique associative data pattern are encoded prior to concatenation. The processor 204 stores the encoded concatenated data in a recurrent neural network (block 1310).

In various embodiments, the original data content is associated to the unique associative data pattern. In addition, the unique associative data pattern enables the original data content to be queried and retrieved from the RNN without using any of the content via the concatenation.

The processor 204 decodes the encoded unique associative data pattern and the encoded original data content to generate the unique associative data pattern and the original data content (block 1312). The processor 204 generate the unique associative data pattern and the original data content of block 1312 in response to a query to the RNN returning the concatenated data.

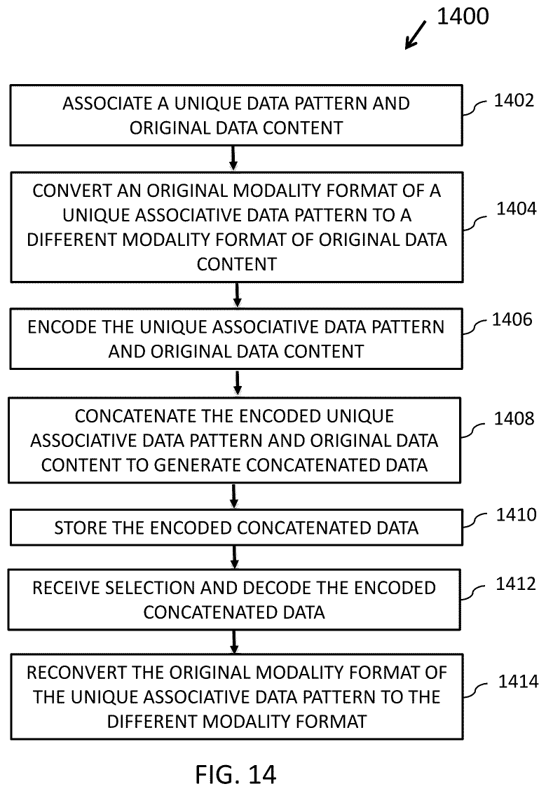

FIG. 14 is a schematic flow chart diagram illustrating another embodiment of a method 1400 for implicit data storage and retrieval using cross-modal Hopfield encoding. At least in the illustrated embodiment, the method 1400 begins by a processor 204 associating a unique associative data pattern and original data content (block 1402).

The method 1400 further includes the processor 204 converting an original modality format of the unique associative data pattern to a different modality format of the original data content (block 1404). The processor 204 also encodes the original data content and the converted unique associative data pattern (block 1406).

The processor 204 concatenates the encoded original data content and the encoded unique associative data pattern to generate encoded concatenated data (block 1408). That is, original data content and the unique associative data pattern are encoded prior to concatenation. The processor 204 stores the encoded concatenated data in a recurrent neural network (block 1410).

In various embodiments, the original data content is associated to the unique associative data pattern. In addition, the unique associative data pattern enables the original data content to be queried and retrieved from the RNN without using any of the content via the concatenation.

The processor 204 receives a selection from and end-user and decodes the encoded unique associative data pattern and the encoded original data content to generate the unique associative data pattern and the original data content in response to a query to the RNN returning the concatenated data (block 1412). The processor 204 reconverts the different modality format of the unique associative data pattern to the original modality format of the unique associative data pattern (block 1414).

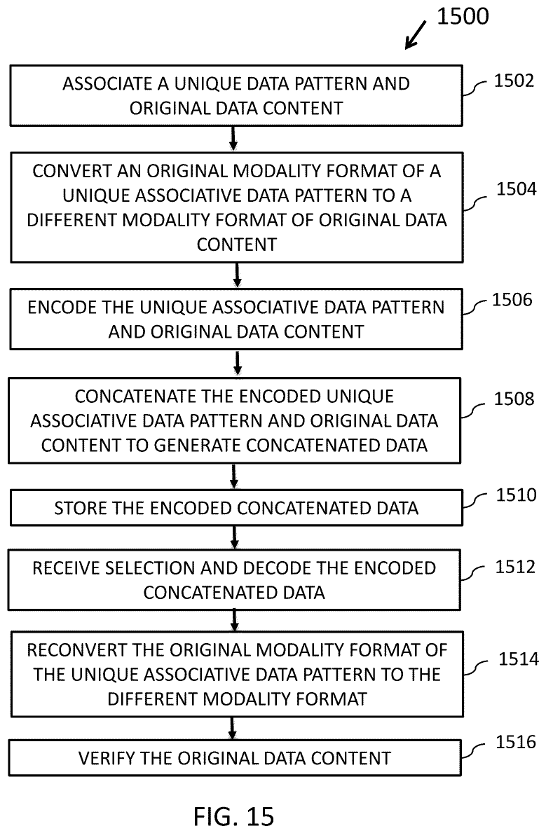

FIG. 15 is a schematic flow chart diagram illustrating another embodiment of a method 1500 for implicit data storage and retrieval using cross-modal Hopfield encoding. At least in the illustrated embodiment, the method 1500 begins by a processor 204 associating a unique associative data pattern and original data content (block 1502).

The method 1500 further includes the processor 204 converting an original modality format of the unique associative data pattern to a different modality format of the original data content (block 1504). The processor 204 also encodes the original data content and the converted unique associative data pattern (block 1506).

The processor 204 concatenates the encoded original data content and the encoded unique associative data pattern to generate encoded concatenated data (block 1508). That is, original data content and the unique associative data pattern are encoded prior to concatenation. The processor 204 stores the encoded concatenated data in a recurrent neural network (block 1510).

In various embodiments, the original data content is associated to the unique associative data pattern. In addition, the unique associative data pattern enables the original data content to be queried and retrieved from the RNN without using any of the content via the concatenation.

The processor 204 receives a selection from an end-user and decodes the encoded unique associative data pattern and the encoded original data content to generate the unique associative data pattern and the original data content in response to a query to the RNN returning the concatenated data (block 1512). The processor 204 reconverts the different modality format of the unique associative data pattern to the original modality format of the unique associative data pattern (block 1514).

In various embodiments, the processor 204 verifies whether the decoded and reconverted unique associative data pattern matches the unique associative data pattern including the original modality format (block 1516). Here, a match may be determined using any of the techniques and/or methods discussed elsewhere herein.

The embodiments may be practiced in other specific forms. The described embodiments are to be considered in all respects only as illustrative and not restrictive. The scope of the technology is, therefore, indicated by the appended claims rather than by the foregoing description. All changes which come within the meaning and range of equivalency of the claims are to be embraced within their scope.

What is claimed is:

1. An apparatus, comprising:
a generation module that converts an original modality format of a unique associative data pattern to a different modality format of an original data content;
a concatenation module that concatenates the original data content and the converted unique associative data pattern to generate a concatenated data; and
a storage module that stores the concatenated data in a recurrent neural network (RNN), wherein:
the original data content is associated to the unique associative data pattern at storage, and
the unique associative data pattern enables the original data content to be queried and retrieved from the RNN without using any of the original data content.

2. The apparatus of claim 1, further comprising:
a selection module that selects a unique data pattern and associates the unique data pattern with the original data content to generate the unique associative data pattern.

3. The apparatus of claim 2, further comprising:
a conversion module that encodes the original data content and encodes the converted unique associative data pattern prior to concatenation of the original data content and the converted unique associative data pattern.

4. The apparatus of claim 1, further comprising:
an end-user associative pattern selection module that receives a selection of a target unique associative data pattern including the original modality format,
wherein the generation module is further configured to convert the original modality format of the target unique associative data pattern to the different modality format.

5. The apparatus of claim 4, wherein:
the generation module is further configured to retrieve the concatenated data using the target unique associative data pattern including the different modality format; and
the apparatus further comprises a deconversion module that, in response to retrieval of the concatenated data, decodes the encoded unique associative data pattern and the encoded original data content of the concatenated data to generate the unique associative data pattern and the original data content.

6. The apparatus of claim 5, wherein the deconversion module is further configured to verify whether the retrieved and decoded unique associative data pattern matches the unique associative data pattern including the original modality format.

7. The apparatus of claim 1, wherein:
the original modality format of the unique associative data pattern includes a text format;
the different modality format of the original data content includes an image format;
the unique associative data pattern includes an ASCII string of characters; and
the RNN comprises a Hopfield Network.

8. A method, comprising:
converting, by a processor, an original modality format of a unique associative data pattern to a different modality format of an original data content;
concatenating, by the processor, the original data content and the converted unique associative data pattern to generate a concatenated data; and
storing, by the processor, the concatenated data in a recurrent neural network (RNN), wherein:
the original data content is associated to the unique associative data pattern at storage, and
the unique associative data pattern enables the original data content to be queried and retrieved from the RNN without using any of the content via the concatenation.

9. The method of claim 8, further comprising:
selecting, by the processor, a unique data pattern; and
associating, by the processor, the unique data pattern and the original data content to generate the unique associative data pattern.

10. The method of claim 9, further comprising:
encoding, by the processor, the original data content and the converted unique associative data pattern prior to concatenation of the original data content and the converted unique associative data pattern.

11. The method of claim 8, further comprising:
receiving, by the processor, a selection of a target unique associative data pattern including the original modality format; and
converting, by the processor, the original modality format of the target unique associative data pattern to the different modality format.

12. The method of claim 11, further comprising:
retrieving, by the processor, the concatenated data using the target unique associative data pattern including the different modality format; and
decoding, by the processor, the encoded unique associative data pattern and the encoded original data content of the concatenated data to generate the unique associative data pattern and the original data content in response to retrieval of the concatenated data.

13. The method of claim 12, further comprising:
verifying, by the processor, whether the decoded and reconverted unique associative data pattern matches the unique associative data pattern including the original modality format.

14. The method of claim 8, wherein:
the original modality format of the unique associative data pattern includes a text format;
the different modality format of the original data content includes an image format;
the unique associative data pattern includes an ASCII string of characters; and
the RNN comprises a Hopfield Network.

15. A computer program product comprising a computer-readable storage medium including program instructions embodied therewith, the program instructions executable by a processor to cause the processor to:
convert an original modality format of a unique associative data pattern to a different modality format of an original data content;
concatenate the original data content and the converted unique associative data pattern to generate a concatenated data; and
store the concatenated data in a recurrent neural network (RNN), wherein:
the original data content is associated to the unique associative data pattern at storage, and
the unique associative data pattern enables the original data content to be queried and retrieved from the RNN without using any of the content via the concatenation.

16. The computer program product of claim 15, wherein the program instructions further cause the processor to:
select a unique data pattern; and
associate the unique data pattern and the original data content to generate the unique associative data pattern.

17. The computer program product of claim 16, wherein the program instructions further cause the processor to:
encode the original data content and the converted unique associative data pattern prior to concatenation of the original data content and the converted unique associative data pattern.

18. The computer program product of claim 15, wherein the program instructions further cause the processor to:
receive a selection of a target unique associative data pattern including the original modality format; and
convert the original modality format of the target unique associative data pattern to the different modality format.

19. The computer program product of claim 18, wherein the program instructions further cause the processor to:
retrieve the concatenated data using the target unique associative data pattern including the different modality format; and
decode the encoded unique associative data pattern and the encoded original data content of the concatenated data to generate the unique associative data pattern and the original data content in response to retrieval of the concatenated data.

20. The computer program product of claim 19, wherein the program instructions further cause the processor to:
verify whether the decoded and reconverted unique associative data pattern matches the unique associative data pattern including the original modality format.
